(19) United States
(12) Patent Application Publication
(10) Pub. No.: US 2025/0272986 A1
(43) Pub. Date: Aug. 28, 2025

(54) Computer-Implemented Method for Training a Model for Analyzing a Traffic Scene and Using a Computer-Implemented Model Trained in this Way

(71) Applicant: Robert Bosch GmbH, Stuttgart (DE)

(72) Inventors: Max Keller, Korntal-Muenchingen (DE); Faris Janjos, Stuttgart (DE); Moritz Nekolla, Pfinztal (DE)

(21) Appl. No.: 19/042,644

(22) Filed: Jan. 31, 2025

(30) Foreign Application Priority Data
Feb. 28, 2024 (DE) 10 2024 201 845.7

(51) Int. Cl. G06V 20/54; G06V 10/82

(52) U.S. Cl. CPC G06V 20/54; G06V 10/82

(57) ABSTRACT

A computer-implemented training method is for training a model for analyzing a traffic scene. The model includes a GNN encoder and an analysis decoder for generating analysis results based on latent features generated by the GNN encoder. Training data elements for the training method each include a graph representation and an image representation of a training scene and an analysis result as groundtruth information. For each training data element, a GNN set of latent features is generated using the GNN encoder based on the graph representation to generate a GNN analysis result using the analysis decoder to determine a distance between the GNN analysis result and the groundtruth information and compare it to an optimization criterion. Based on the image representation and the GNN set of latent features of the training scene, at least one further distance is determined and compared to at least one further optimization criterion.

This application claims priority under 35 U.S.C. § 119 to patent application no. DE 10 2024 201 845.7, filed on Feb. 28, 2024 in Germany, the disclosure of which is incorporated herein by reference in its entirety.

### BACKGROUND

The disclosure relates to a computer-implemented method for training a computer-implemented model for analyzing a traffic scene as well as a computer-implemented method and system for analyzing a traffic scene using a computer-implemented model trained according to the disclosure.

Such a computer-implemented model comprises at least one graphical neural network, referred to as a GNN encoder, for generating latent features based on a graph representation of a traffic scene and an analysis decoder for generating analysis results based on the latent features generated by the GNN encoder.

For the training method, at least one set of training data elements is provided, wherein each training data element comprises at least one graph representation of a training scene and groundtruth information in the form of an analysis result for that training scene.

To train the model, at least the following steps are performed for each training data element: In a first step, a GNN set of latent features, i.e. a GNN representation of the training scene in a latent space, is generated using the GNN encoder based on the graph representation of the training scene. In a further step, at least one GNN analysis result is generated based on the GNN set of latent features using the analysis decoder. Then, a distance £analysis between the at least one GNN analysis result and the groundtruth information is determined and compared to an optimization criterion.

The model in question here is to be trained on analyses of traffic scenes based on a contextual, semantic scene understanding. Examples of applications for this are:
detecting whether a participant/agent in the traffic scene is parking or stopping or stationary for another reason;
identifying a possible lead vehicle for automated cruise control;
speed adjustment, e.g. bus+children->lower speed, no passersby->higher speed;
determining critical/hazardous areas in the traffic scene to avoid such areas;
determining uncertainties of one's own system with respect to the scene in terms of: whether my system knows this scene and can handle this scene with my system.

The graph neural network (GNN) is a subform of an artificial neural network (ANN). ANNs are characterized by processing input data that is present in graph structure, i.e., in the form of graphs with nodes and edges, and applying deep learning (DL) methods. Many architectures fall under the GNN category, such as Graph Convolution Networks (GCN), Graph Attention Networks (GAT), even the very influential transformer approach may be considered a special case of a GNN—see also, Hamilton, “Graph Representation Learning” (2020). A GNN analyzes the input data, recognizes patterns and relationships, and can perform tasks such as classifications or predictions. Typical areas of application are complex problems with many dependencies and interactions between the data points, e.g. semantic analyses.

In the “autonomous driving” area of application and in particular in the prediction and planning of vehicle trajectories, GNNs are characterized by their ability to effectively model relationships and dependencies between different elements in the road environment—see Gao et al., “VectorNet: Encoding HD Maps and Agent Dynamics from Vectorized Representation” (2020). Thus, roads and traffic networks can be represented as graphs, with vehicles, pedestrians, and road infrastructure nodes as interconnected nodes. GNNs can utilize this graph structure to capture complicated interactions between vehicles, account for the impact of adjacent units, and make sound predictions of future trajectories. In this way, autonomous vehicles may anticipate and respond to dynamic situations, such as when lanes are merged, traffic flow changes, or unexpected obstacles. This capability makes GNNs a powerful tool for improving the safety and efficiency of autonomous travel systems. A further significant advantage of GNNs is that they require comparatively low computational time during inference, especially when compared to convolutional neural networks (CNNs).

However, GNNs often have difficulty effectively encoding and understanding distances or spatial relationships within a traffic scene. This is primarily due to GNNs leveraging the topological structure of graphs and focusing on node characteristics and connectivity thereof. The spatial or geometrical relationships between nodes are rather neglected. In typical graph representations, the edges each represent relationships or interactions without explicitly encoding distances or spatial arrangements.

The lack of “spatial understanding” of GNNs has an adverse effect on the contextual, semantic scene understanding and thus on the quality of the analysis results or predicting GNNs.

### SUMMARY

The training approach according to the disclosure aims to improve “spatial understanding” of a GNN-based model for analyzing a traffic scene. For this purpose, spatial information about the respective training scene is also provided to the GNN during the training in addition to the graph representation of a training scene, namely in the form of at least one image representation of the training scene. In this way, the GNN learns a spatial understanding that is then utilized during inference. It is essential that no image representation of the current traffic scene is required for the inference. The GNNs trained according to the disclosure only uses a graph representation of the current traffic scene so that the advantage of a comparatively low computational time of GNNs is retained.

To achieve this, the training method according to the disclosure provides that each training data element further comprises at least one image representation of the training scene. In addition, based on the image representation and the GNN set of the training scene, at least one further distance is determined and compared to at least one further optimization criterion. As long as the optimization criterion and/or the at least one further optimization criterion is not met, the training is continued by modifying at least one parameter of the GNN encoder and/or the analysis decoder.

Preferably, each training scene describes a snapshot of a traffic scene or a time development of a traffic scene over a predetermined time period, in particular in the form of graph representations and image representations of the traffic scene for a sequence of time steps.

In the context of the disclosure, an image representation of the training scene is to be understood as a data representation that immanently reflects the spatial characteristics of the training scenes, in particular distances, relative orientations and spatial relationships between participants and elements of the traffic scene. This could be, for example, a 3D voxel representation or a bird's-eye view (BEV) representation. According to the disclosure, the training data elements are supplemented by this type of representation of the training scenes, because a very extensive and multi-faceted spatial understanding of the training scenes and thus traffic scenes can generally be derived therefrom.

In principle, different further representations of this training scene can be produced in the context of the disclosure based on the image representation and the GNN set of a training scene and compared with one another to determine at least one further distance.

For this purpose, in an embodiment of the training method according to the disclosure, a convolutional neural network, referred to as a CNN encoder, is used to generate a CNN set of latent features, i.e. a CNN representation of the training scene in a latent space, based on the image representation of the training scene.

For example, a vision-transformer architecture could also be used as a CNN encoder, which divides the image representation of the training scene into patches for encoding. Such encoders are particularly suitable for grid-based image representations.

In this case, a first further distance may be determined in the latent space, namely a distance of £_{self-sup} between the GNN set of latent features and the CNN set of latent features.

In addition, based on the CNN set of latent features, at least one CNN analysis result may be generated using the analysis decoder.

Thus, a distance between the GNN analysis result and the CNN analysis result may be determined as a second further distance.

Alternatively or additionally, the distance between the CNN analysis result and the groundtruth information may be determined as the third further distance.

The first, the second and also the third further distances are all influenced directly or indirectly by the image representation of the test scene so that the spatial understanding of the test scene transported with the image representation is incorporated here.

In a further embodiment of the training method according to the disclosure, an image decoder is used to generate a GNN reconstruction of the image representation of the training scene based on the GNN set of latent features. In this case, a distance [symbol] _{GNN-reconstruction} between the image representation of the training scene and the GNN-reconstruction is determined as the fourth further distance.

In the context of the disclosure, an image decoder could also be used to generate a CNN reconstruction of the image representation of the training scene based on the CNN set of latent features.

The fifth further distance could then be a distance [symbol] _{CNN-reconstruction} between the image representation of the training scene and the CNN reconstruction, and the sixth further distance could be a distance between the GNN reconstruction and the CNN reconstruction.

The fourth, fifth and sixth further distances are also all influenced directly or indirectly by the image representation of the training scene, so that the spatial understanding of the training scene transported with the image representation is also incorporated here.

At this point, it is noted that for GNN reconstruction and for CNN reconstruction, different image decoders could be used or one and the same image decoder could be used.

Furthermore, the GNN reconstruction and/or the CNN reconstruction may be generated in the data representation of the image representation of the training scene or in another data representation that immanently reflects the spatial characteristics of the training scenes. Thus, the image representation of the training scene could be in a bird's-eye view (BEV) representation, but a 3D voxel representation could be selected for the GNN reconstruction and/or the CNN reconstruction.

According to the disclosure, the further distances determined in the individual design variants of the training method are each compared with a separate optimization criterion. The actual “learning” is then accomplished by modifying at least one parameter of the GNN encoder and/or the analysis decoder if the optimization criterion and/or the at least one further optimization criterion is not met. Parameters of the remaining DL components of the training architecture, in particular the CNN encoder, the image decoder, if any, are also typically modified.

At this point, it is still noted that the optimization criterion and or the further optimization criterion can simply be a minimization of the corresponding distance or, for example, also a threshold value for the corresponding distance.

As already indicated above, a preferred application of a model trained according to the disclosure is in behavior prediction and/or behavior planning for participants/agents of a traffic scene. Accordingly, the training data elements include at least one future behavior of at least one participant of the respective training scene as groundtruth information. In addition, in this case the analysis decoder generates analysis results in the form of predictions or planning of the behavior of at least one participant in the respective training scene.

Using the training method described above, a very efficient GNN-based model with regards to computational time may be provided for the analysis of a traffic scene, which also has a good understanding of geometric distances and relative orientations, as the GNN is trained with additional reconstruction and latent comparison tasks (self-supervision tasks).

The claimed computer-implemented method for analyzing a traffic scene, in particular for predicting and/or planning a behavior of at least one participant of a traffic scene, is characterized by the use of a trained model as described above. The method comprises at least the following steps:
aggregating scene-specific information of a traffic scene and generate a graph representation of the traffic scene based on the scene-specific information,
using the pre-trained GNN encoder to generate a set of latent features based on the graph representation of the traffic scene,
using the pre-trained analysis decoder to generate an analysis result, in particular a prediction/planning of at least one behavior for at least one participant of the traffic scene, based on the set of latent characteristics.

This method will be explained in more detail in connection with FIG. 3.

Also, the claimed computer-implemented system for analyzing a traffic scene, in particular for predicting and/or planning a behavior of at least one participant of a traffic scene, is characterized by the use of a trained model as described above. The system includes at least the following components:
a perception level for aggregating scene-specific information of a traffic scene, an edge/node encoder for generating an initial graph representation of the traffic scene based on the aggregated scene-specific information,
a model trained according to the disclosure with a GNN encoder for generating a set of latent features based on the graph representation of the traffic scene and with an analysis decoder for generating analysis results, in particular predictions/planning at least one behavior for at least one participant of the traffic scene based on the set of latent features generated by the GNN encoder. The individual components of the system according to the disclosure are explained in more detail in connection with FIGS. 3 and 4.

### BRIEF DESCRIPTION OF THE DRAWINGS

Exemplary embodiments and advantageous further developments of the disclosure are explained in more detail in the following in conjunction with the figures.

FIG. 1 illustrates the mapping of aggregated scene-specific information of a traffic scene onto a set of latent features—in the upper half of the image using a CNN encoder and in the lower half of the image using a GNN encoder.

FIG. 2 shows a training architecture for carrying out a training method according to the disclosure using the example of a model for behavior prediction and/or planning.

FIG. 3 shows the portion of the training architecture shown in FIG. 2 that is used during inference, i.e., behavior prediction and/or planning, during vehicle operation.

FIG. 4 shows a possible implementation of an aggregation component as used in conjunction with a GNN encoder.

### DETAILED DESCRIPTION

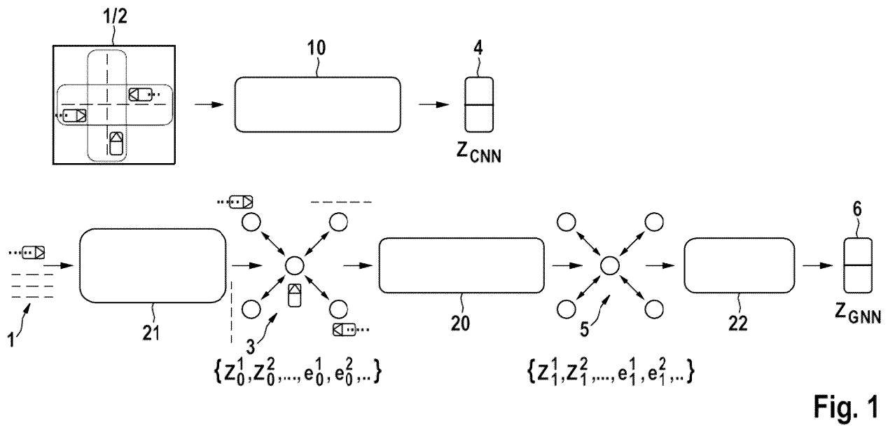

FIG. 1 compares a CNN encoder 10 and a GNN encoder 20 with a set of latent features when mapping scene-specific information 1 and 2 of a traffic scene.

The CNN encoder 10 receives as input an image representation of a traffic scene, which immanently reflects the spatial characteristics of the traffic scene, in particular distances and spatial relationships between participants and elements of the traffic scene. The exemplary embodiment shown here is a so-called grid image from the bird's-eye view perspective (BEV image), i.e. an image representation in the sense of the disclosure. In contrast, the GNN encoder 20 receives a graph 3 as input, which was generated based on scene-specific information 1 with the aid of one or more edges/node encoders 21. Such a graph 3 may be configured differently. However, agents in the traffic scene and/or map elements are usually represented as nodes, while their mutual relationships are modeled by edges between the respective nodes. In FIG. 1, the amount of latent j-nodes z₀^{j} and i-edges e₀ⁱ features are indicated under the representation of graph 3{z₀¹, z₀², . . . , e₀¹, e₀², . . . }.

Both encoders 10 or 20 process their respective input 2 or 3 and generate output representations 4 or 5 in the form of latent (encoded) features. The output representation or output of the CNN encoder 10 is usually already a single latent feature vector z_{CNN} 4, which describes the entire traffic scene.

In principle, the GNN encoder 20 performs a GNN update step, referred to as message passing. With the aid of graph operations (Graph Attention Network/Graph Convolution Network, etc.), information is exchanged between the connected nodes, thereby changing the information content of each node as a function of the adjacent nodes. In order to also exchange information between more remote nodes, this update step can also be repeated several times. In addition, the latent features of all j nodes z₁^{j} and i edges e₁ⁱ generated by the GNN encoder 20 must be processed to a single latent feature vector z_{GNN} 6 descriptive of the scene using an aggregation component 22. For example, the aggregation component could be a multi-layer perceptron (MLP) that receives all of the node and edge features as input. The variable number of nodes and edges is here handled by filling in the input vector with fill values (Nans, 0, . . . ).

The amount of latent j-nodes z₁^{j} and i-edges et is given in FIG. 1 below the initial representation 5 {z₁¹, z₁², . . . , e₁¹, e₁², . . . }. The aggregation step is not required in the case of CNN encoder 10 due to the lack of graph structure.

FIG. 1 illustrates that scene-specific information 1 or an image representation 2 of the traffic scene may not be directly used as input for a GNN encoder, but rather must first be “translated” into a graph by encoding the input data of each edge and each node individually using edges/node encoders to obtain e₀ⁱ, z₀^{j}, wherein e₀ⁱ latent edges and z₀ⁱ latent nodes are features.

Furthermore, FIG. 1 illustrates that GNN encoders, as opposed to CNN encoders, require an aggregation component to generate a latent feature vector describing the overall traffic scene.

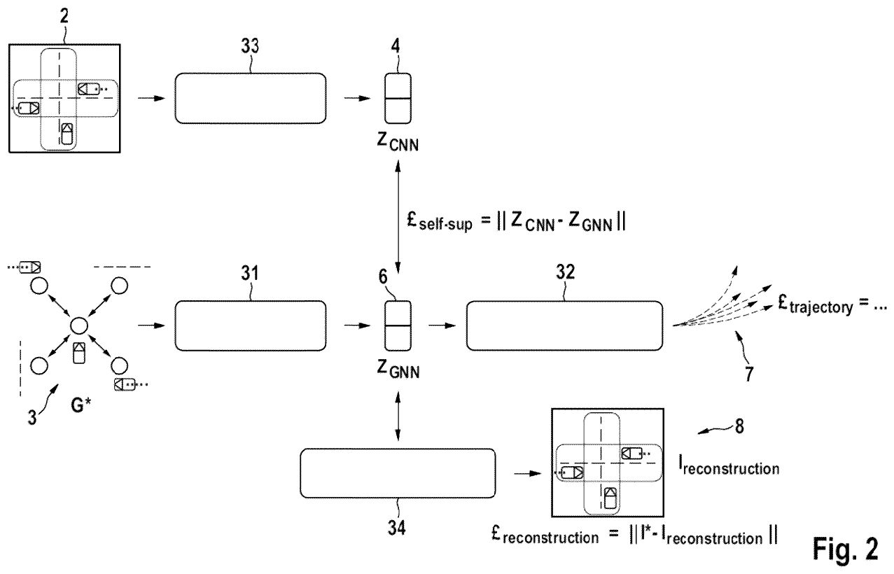

According to these basic explanations, some design variants of the method according to the disclosure for training a model for analyzing a traffic scene are discussed below in connection with FIG. 2. The computer-implemented GNN-based model presented herein is intended to be trained on predicting and/or planning a behavior of at least one participant of a traffic scene.

The model to be trained includes a GNN encoder 31 to generate latent features in the form of a latent feature vector z_{GNN} 6 based on a graph representation 3 of a traffic scene, as described above with reference to FIG. 1. No representation of an edge/node encoder and an aggregation component was provided in FIG. 2 for clarity.

Furthermore, the model to be trained includes an analysis decoder 32 for generating analysis results based on the latent features generated by the GNN encoder 31, i.e., based on the latent feature vector z_{GNN} 6. In the exemplary embodiment described herein, the analysis decoder 32 is a trajectory decoder that generates behavior predictions, and behavior planning for individual traffic scene participants in the form of trajectory data 7.

For the training method, at least one set of training data elements is provided, wherein each training data element comprises at least one graph representation 3 of a training scene and groundtruth information in the form of at least one trajectory of at least one participant in the training scene. The groundtruth information is not shown in FIG. 2.

According to the disclosure, each training data element also comprises at least one image representation 2 of the training scene.

Different data representations can be selected for the image representation 2 of the training scenes. However, the selected data representation should immanently reflect the spatial characteristics of the training scenes, in particular distances and spatial relationships between participants and elements of the traffic scene. For example, a 3D voxel representation or a bird's-eye view (BEV) representation are suitable. For example, vehicles may be represented by bounding boxes. The past trajectories of agents may be represented by faded bounding boxes or by using multiple image channels. Map information can be represented by different lines of different thickness and color. In the exemplary embodiment described herein, a BEV representation was selected for the image representation 2 of the training scenes.

For each training date element, the following steps are carried out:

Based on the graph representation 3 of the training scene, a GNN set of latent features in the form of a latent feature vector z_{GNN} 6 is generated using the GNN encoder 31. Based on the latent feature vector z_{GNN} 6, a GNN analysis result in the form of at least one GNN trajectory 7 is then generated using the trajectory decoder 32. Then, a distance [symbol] _{analysis} or [symbol] _{trajectory} is determined between the trajectories of the GNN analysis result 7 and the groundtruth information and compared to an optimization criterion. The optimization criterion may consist in minimizing the distance [symbol] _{trajectory} or may also be predetermined by a threshold value for the distance.

According to the disclosure, based on the image representation 2 of the training scene and the GNN set of the training scene-latent feature vector z_{GNN} 6—at least one further distance is determined and compared to at least one further optimization criterion. The parameters or at least one parameter of the GNN encoder 31 and/or analysis decoder 32 are then modified during the course of the training as long as the optimization criterion and/or the at least one further optimization criterion is not met.

To determine further distances based on the image representation 2 and the GNN set 6 of the training scene, the training architecture shown in FIG. 2 further comprises a CNN encoder 33 that generates a CNN set of latent features in the form of a latent feature vector z_{CNN} 4 based on the image representation 2.

This opens up the possibility of determining a distance [symbol] _{self-sup} between the GNN set of latent features-feature vector z_{GNN} 6—and the CNN set of latent features-feature vector z_{CNN} 4—as the first further distance [symbol] _{self-sup}=∥z_{CNN}−z_{GNN}∥.

In addition, the trajectory decoder 32 may generate at least one CNN analysis result based on the feature vector z_{CNN} 4. As a second further distance, a distance between the trajectories of the GNN analysis result and the trajectories of the CNN analysis result may then be determined. However, a third further distance may also be determined, namely a distance between the trajectories of the CNN analysis result and the groundtruth information.

Furthermore, the training architecture shown in FIG. 2 includes an image decoder 34 that generates a GNN reconstruction 8 of an image representation of the training scene based on the GNN set of latent features—feature vector z_{GNN} 6. The data representation of the image representation 2 of the training data element can be selected—i.e. a BEV representation here—or another data representation, which immanently reflects the spatial characteristics of the training scenes. For example, the image decoder 34 could also generate reconstructions in the form of semantic maps of the training scene.

A distance [symbol] _{GNN-reconstruction} between the image representation 2 of the training scene and the GNN reconstruction 8 may then be determined as the fourth further distance.

By reconstructing BEV images or even another image representation of the test scene from the aggregated latent GNN features z_{GNN} 6, the GNN-based model can better learn the geometrical relationships (distances and orientations) during the training as these relationships are present in the BEV images.

The image decoder 34, or another image decoder not shown here, could also generate a CNN reconstruction of the image representation of the training scene based on the CNN set of latent features—feature vector z_{CNN} 4. In this case, a distance [symbol] _{CNN-reconstruction} between the image representation 2 of the training scene and the CNN reconstruction could be determined as the fifth further distance.

As the parameters of all involved DL components of the training architecture are typically modified during the training process, the fourth and fifth distances contribute to training the image decoder(s) 34, such that the reconstructed image representations match the image representation 2 of the training data set as closely as possible, even if these image representations are present in different data representations.

Finally, in the present exemplary embodiment, a sixth further distance could also be determined, namely a distance between the GNN reconstruction and the CNN reconstruction.

In summary, it can be noted:

Due to the additional distances and optimization criteria, the GNN-based model with GNN encoder 31 and analysis or trajectory decoder 32 receives an additional signal during training, through which it implicitly learns a geometrical understanding similar to that of CNN-based models.

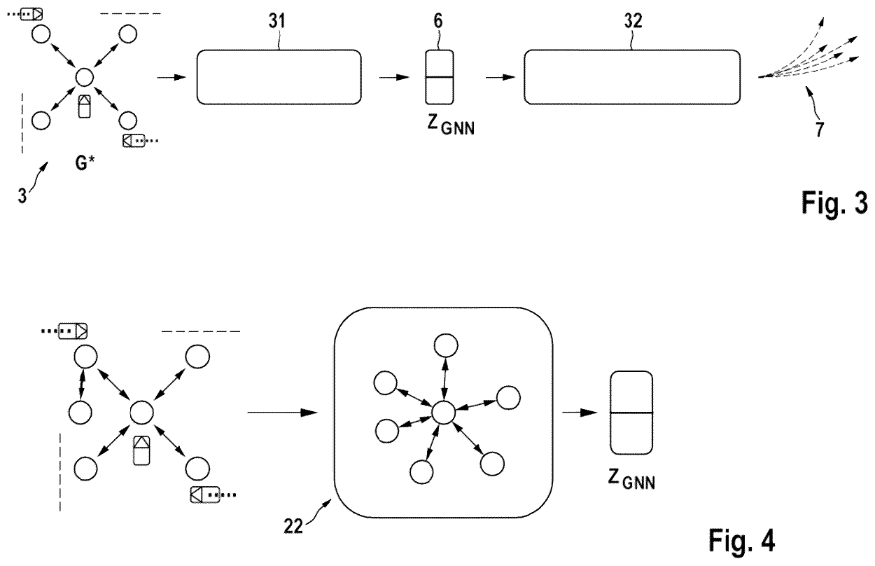

As already mentioned, FIG. 3 shows the part of the training architecture shown in FIG. 2 that is used for the inference, i.e. analysis of a traffic scene during vehicle operation, or in the present exemplary embodiment for behavior prediction and/or for behavior planning.

A computer-implemented system according to the disclosure for performing such an analysis or behavior prediction/planning includes a perception level for aggregating scene-specific information of the traffic scene, typically from different sources of information. These can be in-vehicle sensors, such as LiDAR sensors, radar sensors and/or RGB cameras installed on the ego vehicle, or non-vehicle sensors, such as LiDAR sensors, radar sensors, and/or RGB cameras installed in or on infrastructure elements. Other possible sources of information include stored map information as well as retrievable weather and road condition information, traffic situation information, etc. The information from the different sources of information is aggregated from the perception level and pre-processed to context information.

Furthermore, the system according to the disclosure comprises an edge/node encoder for generating an initial graph representation 3 of the traffic scene based on the aggregated scene-specific information, as well as the components trained according to FIG. 3, namely the GNN encoder 31 for generating a set of latent features z_{GNN} 6 based on the graph representation 3 and the traffic scene, and the analysis or trajectory decoder 32 for generating trajectories 7 as predictions/planning of at least one behavior for at least one participant of the traffic scene, based on the set of latent features 6 generated by the GNN encoder z_{GNN} 31.

As only the GNN components 31 and 32 trained according to the disclosure are used during the inference, i.e. during the runtime in the vehicle, both computational effort and computational time are low compared to CNN-based models.

FIG. 4 shows a possible embodiment of the aggregation component 22 of FIG. 1.

The aggregation component 22 is realized here in the form of a further GNN-based network by having a central uninitialized node connected in a star-shape to all other nodes of the graph, while no further connections exist between the nodes of the previous graph. This form of the aggregation component is described, for example, in Janjos et al. “SAN: Scene Anchor Networks for Joint Action-Space Prediction” (2022). After the GNN update step (Message Passing, . . . ), the latent features of the middle node can then be considered aggregate latent features z_{GNN}.

What is claimed is:

1. A computer-implemented training method for training a model for analyzing a traffic scene, comprises:
generating latent features based on a graph representation of a traffic scene using a graphical neural network (“GNN”) encoder; and
generating analysis results based on the latent features generated by the GNN encoder using an analysis decoder;
wherein at least one set of training data elements is provided for the training method, each training data element comprising at least:
a graph representation of a training scene, and
groundtruth information including an analysis result for the training scene, wherein at least the following is performed for each training data element:
using the GNN encoder to generate a GNN set of latent features based on the graph representation of the training scene,
using the analysis decoder to generate at least one GNN analysis result based on the GNN set of latent features, and
determining a distance between the at least one GNN analysis result and the groundtruth information and comparing the distance to an optimization criterion,
wherein each training data element further comprises at least one image representation of the training scene,
wherein at least one further distance is determined based on the image representation and the GNN set of latent features of the training scene and compared to at least one further optimization criterion, and
wherein at least one parameter of the GNN encoder and/or the analysis decoder is modified when the optimization criterion and/or the at least one further optimization criterion is not met.

2. The training method according to claim 1, wherein based on the at least one image representation of the training scene, a convolutional neural network (“CNN”) set of latent features is generated using a CNN encoder.

3. The training method according to claim 2, further comprising:
determining a distance between the GNN set of latent features and the CNN set of latent features as a first further distance of the at least one further distance.

4. The training method according to claim 3, wherein:
at least one CNN analysis result is generated based on the CNN set of latent features using the analysis decoder, and
a distance between the GNN analysis result and the CNN analysis result is determined as a second further distance of the at least one further distance, and/or a distance between the CNN analysis result and the groundtruth information is determined as a third further distance of the at least one further distance.

5. The training method according to claim 4, wherein:
based on the GNN set of latent features, a GNN reconstruction of the at least one image representation of the training scene is generated using an image decoder, and
a distance between the image representation of the training scene and the GNN reconstruction is determined as a fourth further distance of the at least one further distance.

6. The training method according to claim 5, wherein:
based on the CNN set of latent features, a CNN reconstruction of the image representation of the training scene is generated using the image decoder, and
a distance between the image representation of the training scene and the CNN reconstruction is determined as a fifth further distance of the at least one further distance, and/or a distance between the GNN reconstruction and the CNN reconstruction is determined as a sixth further distance of the at least one further distance.

7. The training method according to claim 1, wherein each training scene describes a snapshot of a traffic scene or a time development of a traffic scene over a predetermined time period, and includes graph representations and image representations of the traffic scene for a sequence of time steps.

8. The training method according to claim 1, wherein a data representation is selected as the image representation of the training scenes, which immanently reflects spatial characteristics of the training scenes including distances and spatial relationships between participants and elements of the traffic scene and includes a 3D voxel representation or a bird's-eye view representation.

9. The training method according to claim 6, wherein the GNN reconstruction and/or the CNN reconstruction is generated in the data representation of the image representation of the training scene or in another data representation that immanently reflects spatial characteristics of the training scenes.

10. The training method according to claim 1, wherein:
a model for predicting and/or planning a behavior of at least one participant of a traffic scene is trained,
the set of training data elements comprises at least one future behavior of at least one participant of the respective training scene as the groundtruth information, and
analysis results including predictions or planning the behavior of at least one participant of the respective training scene are generated using the analysis decoder.

11. A computer-implemented method for analyzing a traffic scene for predicting and/or planning a behavior of at least one participant of a traffic scene, using a model trained according to the method of claim 1, the method comprising:
aggregating scene-specific information of a traffic scene and generating a graph representation of the traffic scene based on the scene-specific information;
using a pre-trained GNN encoder for generating a set of latent features based on the graph representation of the traffic scene; and
using a pre-trained analysis decoder to generate an analysis result including a prediction/planning of at least one behavior for the at least one participant of the traffic scene, based on the set of latent features.

12. A computer-implemented system for analyzing a traffic scene including predicting and/or planning a behavior of at least one participant of a traffic scene, the system comprising:
a perception level configured to aggregate scene-specific information of a traffic scene;
an edge/node encoder configured to generate an initial graph representation of the traffic scene based on the aggregated scene-specific information,
a model trained in accordance with the training method of claim 1, the model including:
a GNN encoder configured to generate a GNN set of latent features based on the graph representation of the traffic scene, and
an analysis decoder configured to generate analysis results including predictions/planning of at least one behavior for the at least one participant of the traffic scene, based on the GNN set of latent features generated by the GNN encoder.

13. A vehicle having a computer-implemented system for analyzing a traffic scene for predicting and/or planning a behavior of at least one participant of a traffic scene according to claim 12.
